(19) United States
(12) Patent Application Publication
(10) Pub. No.: US 2016/0305365 A1
(43) Pub. Date: Oct. 20, 2016

(54) PISTON WITH COMPLEX SHAPED COMBUSTION BOWL AND COOLING GALLERY AND METHOD OF CONSTRUCTION THEREOF

(71) Applicant: Federal-Mogul Corporation, Southfield, MI (US)

(72) Inventors: Norbert G. Schneider, Ann Arbor, MI (US); Jeffrey L. Riffe, Troy, MI (US)

(21) Appl. No.: 15/132,924

(22) Filed: Apr. 19, 2016

Related U.S. Application Data
(60) Provisional application No. 62/150,154, filed on Apr. 20, 2015.

(51) Int. Cl. F02F 3/26; B23P 15/10; B21K 3/00; F02F 3/00; F02F 3/16

(52) U.S. Cl. CPC F02F 3/26; F02F 3/003; F02F 3/16; F02F 3/0084; B21K 3/00; B23P 15/10; F02F 2003/0061

(57) ABSTRACT

A piston and method of construction thereof is provided. The piston has a lower member with diametrically opposite skirt portions and axially aligned pin bores and an upper member joined to the lower member. The upper member has a substantially planar upper combustion surface and a combustion bowl depending from the upper combustion surface. An undercrown surface is formed directly opposite the combustion bowl and a combustion bowl rim transitions the combustion bowl with the upper combustion surface. At least one of the combustion bowl, the undercrown surface and the upper combustion surface has a machined surface and an “as forged” surface.

### CROSS-REFERENCE TO RELATED APPLICATION

This application claims the benefit of U.S. Provisional Application Ser. No. 62/150,154, filed Apr. 20, 2015, which is incorporated herein by reference in its entirety.

### BACKGROUND

1. Technical Field

The invention relates generally to pistons for internal combustion engines, and more particularly to forged diesel engine pistons.

2. Related Art

It is known in internal combustion engine applications, particularly with respect to diesel engines, to provide pistons with bodies formed with a closed gallery, including inlet and outlet openings, for the ingress and egress of cooling oil from the engine crankcase. The oil circulates through the gallery and cools parts of the piston which are most susceptible to damage from combustion heat. The annular upper rims, extending around combustion bowls depending into an upper crown surface, are particularly susceptible to damage from heat.

The cooling galleries are generally annular or ring-shaped with constant shaped cross-sections and are generally formed in radially inward alignment with the piston ring belt. The galleries are adjacent the top wall and rim of the piston body and are bounded by an inner wall adjacent the combustion bowl. The oil galleries can be either open or closed. If closed, the gallery channel is substantially closed at the bottom by a bottom wall, wherein the bottom wall can be provided with inlet and outlet openings for the ingress and egress of cooling oil.

Traditionally, the combustion bowls of diesel engines have symmetric circular shapes and have smooth unbroken surfaces from the outer rims radially inwardly to the depressed valleys and to a central peak. Today, however, new combustion bowls are being designed with non-traditional, complex shapes. It is understood that these non-traditional shapes are utilized in order to burn fuel more effectively and with less undesirable emissions. However, the complex combustion bowl shapes make the cooling of the combustion bowls and rims extending thereabout with conventional, constant shaped cooling galleries, as viewed in plan view and in cross-section, more difficult. Conventional machining with turning operations will not provide oil galleries with similar or corresponding complex shapes as the complex shaped combustion bowls.

If the differences in wall structure extending between the combustion bowls and the oil galleries result in significantly different and varying wall thicknesses, or if the walls are too thick to be adequately cooled by the oil being circulated in the oil galleries, then “hot spots” in the piston can occur. Hot spot areas can create weakened spots in the piston where the material could crack or fail. If a piston fails, this results in an engine failure, thereby causing major expense and perhaps requiring a replacement engine for the vehicle.

It is an object of the present invention to provide a forged steel piston, and a method of forming a forged steel piston, which have non-traditional complex-shaped combustion bowls and corresponding cooling galleries that provide relatively thin and uniform wall thickness in order to avoid overheating concerns, and which also provide the piston with a minimal finished compression height tolerance, thereby enhancing the performance of the resulting piston, and also allowing the “as forged” compression height tolerance to be increased, thereby making the manufacture of the piston economical.

### SUMMARY OF THE INVENTION

The invention provides oil galleries within forged steel pistons that are contoured to mate with complex shaped combustion bowls, as well as methods for forming such oil galleries and complex shaped combustion bowls, which provide uniform or substantially uniform wall thicknesses between the entirety of combustion bowls and the entirety of oil galleries. The invention minimizes or eliminates the formation of hot spots within the piston and allows the oil in the galleries to maintain the combustion bowl rims and other areas of the pistons and combustion bowls within acceptable temperature limits. The invention further enhances the ease and reliability of manufacturability of pistons constructed in accordance with the invention, and further, provides an optimal process for ensuring the dimensional thickness of the walls extending between the combustion bowl, oil gallery and undercrown surface are optimal to enhance the strength and useful life of the piston. Further yet, the invention provides a process in which the compression height tolerance of the forged piston can be minimized without jeopardizing the structural integrity of the piston.

The galleries are formed having the same or substantially similar complex shapes as the combustion bowls. The galleries are initially formed by forging and then can be at least partially machined by machining operations, such as turning, for example, where possible, to enlarge the galleries and to finish certain surfaces. Areas and surfaces in the galleries which cannot be finished by machine turning operations, such as recesses and bulges, or are otherwise considered unnecessary to be further processed to enhance performance of the piston, can be left in their initial “as forged” condition. During the machining operation, an annular groove can be formed extending the axial full depth of the oil gallery in a direction toward the bowl rim and upper combustion surface to form the combustion bowl wall with a uniform or substantially uniform thickness.

In accordance with one aspect of the invention, a piston is provided having a lower member with diametrically opposite skirt portions and axially aligned pin bores and an upper member joined to the lower member. The upper member has a substantially planar upper combustion surface and a combustion bowl depending from the upper combustion surface with an undercrown surface formed directly opposite the combustion bowl and a combustion bowl rim transitioning the combustion bowl with the upper combustion surface. At least one of the combustion bowl, the undercrown surface and the upper combustion surface has a machined surface and an “as forged” surface.

In accordance with one aspect of the invention, a method of constructing a piston is provided. The method includes forming a lower member having diametrically opposite skirt portions and axially aligned pin bores and forging an upper member having a substantially planar upper combustion surface and a combustion bowl depending from the upper combustion surface with an undercrown surface formed directly opposite the combustion bowl and a combustion bowl rim transitioning the combustion bowl with the upper combustion surface. Further, joining the lower member to the upper member. Further yet, machining a portion of at least one of the upper combustion surface, the combustion bowl and the undercrown surface, and leaving a portion of at least one of the upper combustion surface, the combustion bowl and the undercrown surface “as forged”.

The upper combustion surface within the combustion bowl and the undercrown surface directly beneath the combustion bowl can be initially forged, with extra material being intentionally left in a localized region during the forging process, thereby resulting in an increased wall thickness in the localized region extending between the combustion bowl and the undercrown surface directly beneath the combustion bowl. Then, subsequent to forging, the localized region of the increased thickness material can be finish machined to form the precise and optimal thickness of the wall extending between the combustion bowl and the undercrown surface directly beneath the combustion bowl.

The upstanding annular wall of the complex shaped combustion bowl, extending between a floor of the combustion bowl and the upper combustion bowl rim, can be initially forged having a draft angle, such that the upstanding wall converges from an uppermost combustion surface toward the floor of the combustion bowl. This way, the forging tool is assured of not getting stuck while being drawn outwardly after forming the combustion bowl. Then, if desired to form a purely cylindrical upstanding wall, or if desired to form a re-entrant wall, finish machining can be performed.

In accordance with a further aspect of the invention, the upper combustion surface of the piston can be initially forged with extra material being intentionally left thereon during the forging process, at least in an annular localized region, and then, the upper combustion surface can be finish machined to the desired height relative to a pin bore axis, thereby establishing an optimal and precise compression height of the piston within a reduced tolerance limit.

In accordance with yet a further aspect of the invention, selected “as forged” surfaces of the piston can be surface treated to remove any residues or particles without significantly altering the dimension of the treated surface. Such surface treatments can include shot blasting, etching, fluid treatment or otherwise.

The term “complex” as used herein refers to the shape of the combustion bowl in the piston crown which is not traditionally shaped, either in its outer perimeter, or inside the outer perimeter, or both. “Complex” shapes refers to all shapes of a combustion bowl other than traditional and which can have, for example, edges which include straight, curved, or arced sections, or which have bumps, protrusions, ribs, recesses and the like either in the bowl or, its outer perimeter, or both. In general, complex shapes are any shapes which are not machinable by conventional machine-turning operations.

The present invention is preferably utilized for pistons for diesel engines, although the invention can also be utilized for pistons for any internal combustion engine.

### BRIEF DESCRIPTION OF THE DRAWINGS

These and other features and advantages of the present invention will become more readily appreciated when considered in connection with the following detailed description and appending drawings, wherein:

FIG. 1 illustrates a piston with a closed oil gallery in accordance with one aspect of the invention;

FIG. 2 is a schematic plan view of an “as forged” piston crown formed in accordance with the invention depicting a representative complex shape of a combustion bowl;

FIGS. 2A-2C depict further representative shapes of a combustion bowl;

FIG. 3 is a cross-section taken generally along line 3-3 of FIG. 2; and

FIG. 4 is another cross-section of the piston crown similar to FIG. 3, following machining of at least one surface of the forged upper member 12.

### DESCRIPTION OF THE PREFERRED EMBODIMENTS

Referring in more detail to the drawings, FIG. 1 illustrates a representative piston 10 constructed in accordance with one aspect of the invention. The piston 10 includes an upper member 12 and a lower member 14 joined to one another, wherein the lower member includes skirt portions 16 and pin bosses 18 with pin bores 20 aligned axially along a pin bore axis 21. The upper member 12 and lower member 14 are fixedly secured together, such as via welding, including view friction welding, induction welding, or otherwise, to form the piston 10.

The piston 10 has a cooling gallery 22 in which oil is circulated in order to maintain the temperature of the piston 10, particularly an upper combustion surface 24, which includes a combustion bowl 26 depending therein and combustion bowl rim 28 transitioning the uppermost combustion surface 24 with an upstanding annular combustion bowl wall, also referred to as sides or simply as wall 30, of the combustion bowl 26. The cooling gallery 22 can be either open or closed as well understood in the art. If closed, the bottom wall or floor of the cooling gallery 22 is typically included as part of the lower member 14, and can include oil inlet and outlet openings 32, with only one shown in cross-section, by way of example and without limitation.

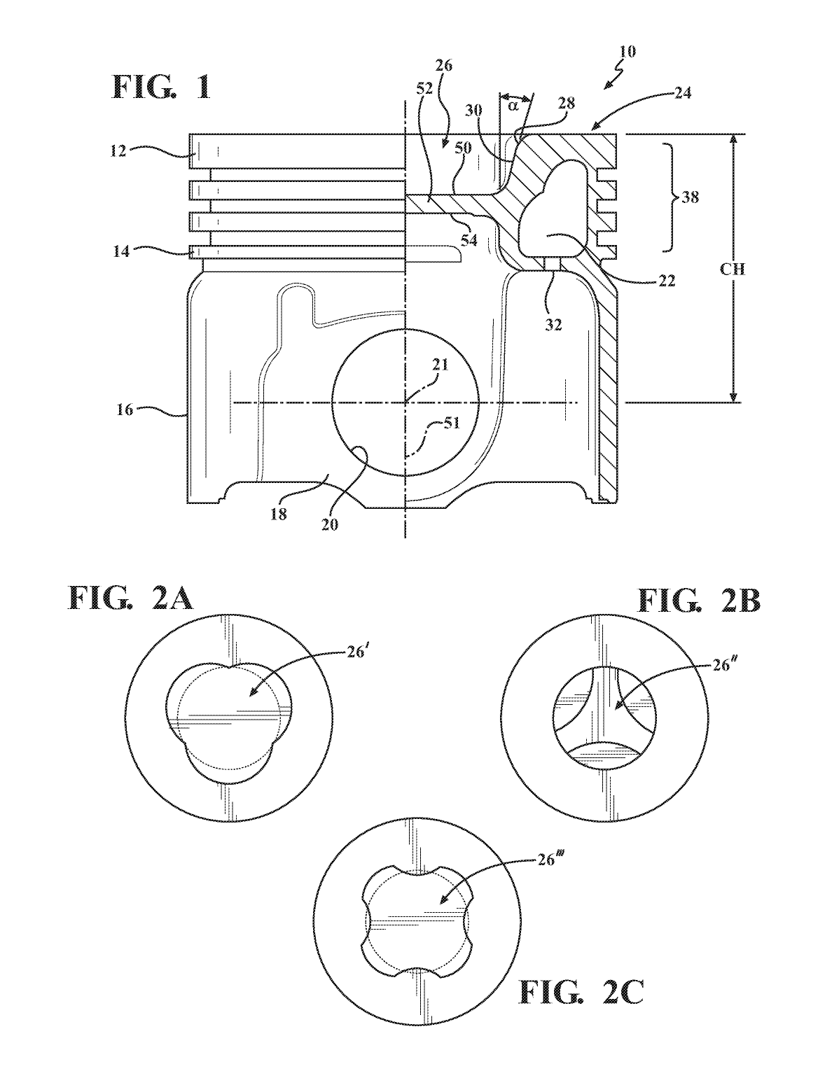

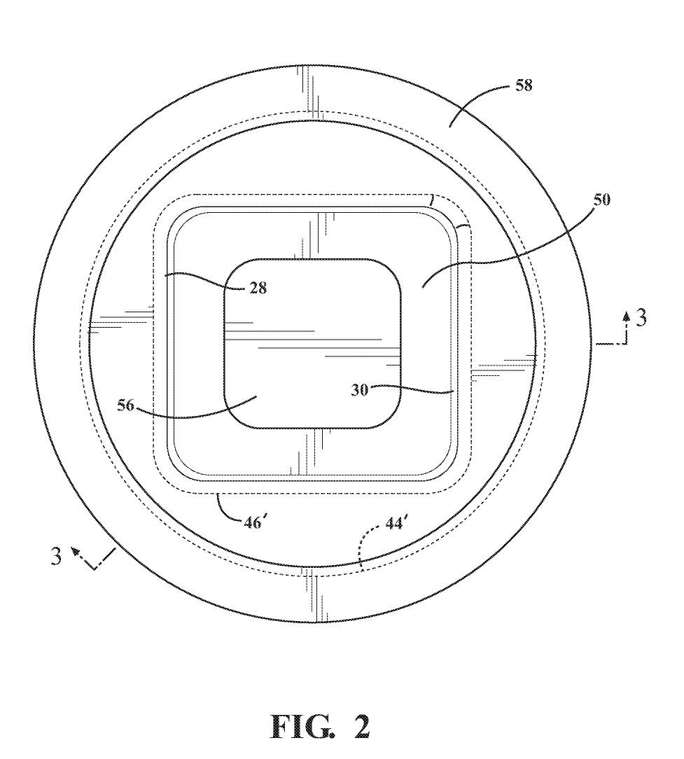

A representative complex combustion bowl 26 is depicted as essentially a square shape with four upstanding sides established by the wall 30. In the shape depicted, the upstanding sides are straight along a direction transverse to a longitudinal axis 51, with rounded corners interconnecting the adjacent sides. It is to be understood that the shape of the combustion bowl 26 and the linearity of the sides is merely one example of a complex combustion bowl. In accordance with the invention, the combustion bowl 26 can have any peripheral shape or internal shape, with any number of sides or side portions bounding the combustion bowl 26. The shape of the combustion bowl 26 can be complex either in its outer periphery, as shown in FIG. 2A, be complex in the radially inner areas of the bowl, as shown in FIG. 2B, or be complex with respect to both the outer periphery and the inner areas as shown in FIG. 2C. FIGS. 2A, 2B and 2C are representative of these three general types of complex shaped combustion bowls 26′, 26″, 26′″. The present invention provides a cooling gallery that can accommodate combustion bowls with such complex shapes, while at the same time, providing the piston 10 with a high strength, durable structure that results in a long and useful life.

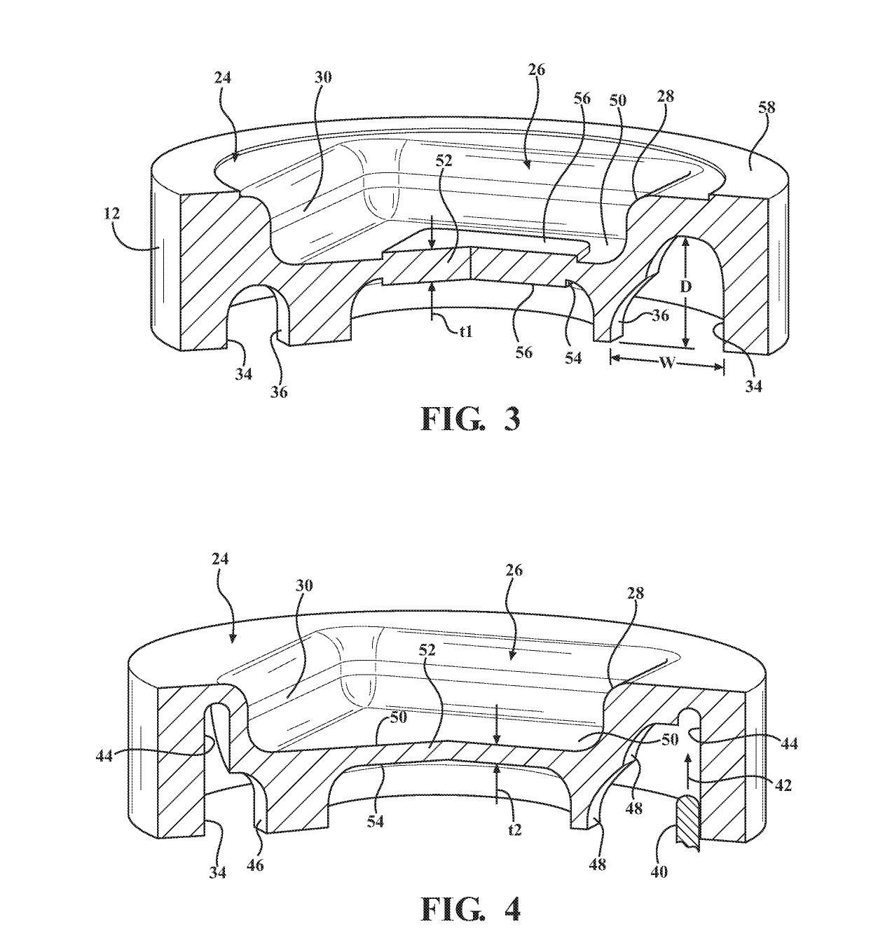

The upper member 12 and lower member 14 are made of a steel material. The steel material can either be identical or different between the two members 12, 14. The shape of the upper member 12 is formed, at least initially, by a forging process. In accordance with a preferred embodiment of the invention, a cooling gallery channel portion 34 in the upper member 12 is made by the same process as the combustion bowl 26, or portions thereof. In the embodiment shown, the cooling gallery channel portion 34 in the upper member 12 is initially formed by the forging process (representative example shown “as forged” and prior to machining in FIGS. 2 and 3), followed by a machining process is selected areas, as desired (representative example shown as finish machined in FIG. 4).

In accordance with a preferred embodiment, the forging die for forming the combustion bowl 26 and the forging die for forming the cooling gallery portion 34 have corresponding, mating shapes. The two dies have similar straight sections and similar curved sections that correspond to one another.

A cross-section of the piston crown 10 after the forging process is shown in FIG. 3. The forging process forms an annular pocket 36 that does not necessarily have a circumferential uniform width “W” or a uniform depth “D”. The width W of the pocket 36 is greater in the portions where the sides 30 of the combustion bowl 26 are furthest from the outside, generally cylindrical surface, which ultimately forms a ring belt region 38 of the upper member 12. Similarly, the areas where the pocket 36 is the narrowest is at the corners or intersections between the side of the combustion bowl 26.

The depth D of the pocket 36 made by the forging is dependent on the dies used in the forging process. There is a practical limit to the depth that forging dies can penetrate in a steel upper member 12 and still be used repeatedly before they need replacing or refurbishing.

As a subsequent step in forming the cooling gallery portion 34 in accordance with a preferred embodiment of the invention, the finished shape of the cooling gallery portion 34 is machined to the shape shown in FIG. 4. In one step in the machine processing, a machining tool represented by the tool member 40 is inserted into the pocket 36 formed by the forging process (in the direction of arrow 42) and used to finish the outer surface of cooling gallery portion 34 and to form an annular groove 44, entirely around the combustion bowl 26. This machine-turning extends the cooling gallery portion 34 into the upper reaches of the piston crown (near the top ring groove and adjacent the upper combustion surface 24). The groove 44, which is fully machined, extends above the initial pocket 36 formed in the forging process.

“Machine-turning” or simply “turning” is a machining process in which a cutting tool, typically a non-rotary tool bit, moves linearly while the work piece rotates, such as on a lathe. “Machining turning” can refer to such a cutting or finishing operation on either the internal surfaces or the external surfaces of a work piece. In machining some of the surfaces of an oil gallery channel thereon, the machine-turning finishes or forms internal surfaces.

The machine-turning processing can also be used to machine and finish some of the inner surfaces of the cooling gallery portion 34, such as surface 46. Due to the complex shape in the cooling gallery portion 34 in order to follow the complex shape of the combustion bowl 26, a plurality of bumps or recesses can be formed on the inside gallery surface by the forging die in the forging process. Due to the turning procedure used in the machining process, the recesses and areas between bumps are left unfinished (i.e. not machined) in this step. Inner gallery channel surfaces 48 in FIG. 4 are not finished and remain in their original condition after forging. In FIG. 2, the outer circumference of the finished annular groove 44 is indicated by hidden line 44′. In addition, an inner finished surface of the complex shaped cooling gallery portion 34 is indicated by the hidden line 46′.

In a forging operation in accordance with one aspect of the invention, the cooling gallery portion 34 in the lower surface of the upper member 12 will be formed at the same time that another forging die is forming the complex shaped combustion bowl 26 depending in the upper combustion surface 24. The inventive process and resulting inventive structure provides the cooling gallery portion 34 having a similar or substantially the same perimeter inner shape as the outer perimeter shape of the complex-shaped combustion bowl 26. This minimizes the thicknesses of the upstanding wall 30 between the cooling gallery portion 34 and combustion bowl 26 and makes the wall thicknesses around the outside of the combustion bowl 26 uniform or substantially uniform. Due to practical limits of the forging and machining processes, the thicknesses of all of the walls will not be exactly the same around the circumference of the combustion bowl 26. The present invention, however, makes the wall thickness as thin and uniform as practical around the entire oil gallery, while at the same time provides the wall thickness with a desired high strength. This allows oil introduced in the cooling gallery 22 to maintain the temperature of the combustion bowl wall surfaces and combustion bowl rim 28 within appropriate limits and avoids harmful hot spots, while providing the piston 10 with a long, useful life.

To facilitate forging the upper member 12, the combustion bowl wall 30 is forged having a draft angle α such that the surface of the wall 30 facing radially inwardly toward the combustion bowl 26 converges from the uppermost region of the upper combustion surface 24, shown as from the combustion bowl rim 28, toward a recessed floor 50 of the combustion bowl 26. In the embodiment illustrated, the entirety of the combustion bowl wall 30 converges from the upper combustion surface 24 to the floor 50, and also remains “as forged”. As such, as shown in FIG. 2, the wall 30 can be seen converging from the combustion bowl rim 28 to the floor 50 in plan view. With the wall 30 being slightly inclined as such, the forging die is assured of being free upon withdrawal of the forging tool after forging the combustion bowl 26. Further, the frictional forces experienced by the forging die are minimized, thereby reducing the wear on the forging die during use, thereby extending the useful life of the forging die. The draft angle α of the wall 30 can be formed as desired, such as between about 1-15 degrees, with one presently preferred embodiment having about an 11 degree draft from a central vertical axis, also referred to as central longitudinal axis 51 along which the piston reciprocates, or less. Of course, it is anticipated that the wall 30 can be finished machined, if desired, thereby forming a purely cylindrical wall surface, if desired. If left “as forged”, any of the forged surfaces can be surface treated, such as via shot blasting, etching, fluid or chemical treatment, or otherwise, to remove residue or particles, without any significant alteration of the finished dimension or tolerance.

To further facilitate forging the upper member 12, and in particular, a central wall 52 of the combustion bowl 26 extending between the floor 50 of the combustion bowl 26 and an undercrown surface 54 directly beneath the combustion bowl 26, at least a central portion of the central wall 52 is initially forged having an increased thickness t1 (FIG. 3) relative to a finished thickness t2 (FIG. 4) of the wall 52. The initial thickness t1 is formed by the forging dies in such a way that over-compressing the central portion of the central wall 52 is avoided by forging excess material 56 on at least one, or both sides of the central wall 52, wherein the excess material 56 can be subsequently removed via machining. By avoiding over-compression of the central wall 52 during the forging process, as a result of forging a region of the excess material 56, the material within the region of the central wall 52 is not overly stressed nor overly thinned and weakened. Then, upon forging the upper member 12, the portion of the central wall 52 including the excess material 56, such as on the central region of the floor 50 and/or central region of the undercrown 54, can be finish machined and/or surface treated via any suitable machining and surface treating operation, such as milling and shot blasting, for example, or otherwise, as discussed above. If desired, if the excess material 56 is formed on the floor 50, the entire floor 50 can be finished machined, or only the region including the excess material 56 can be machined, as desired. Accordingly, if desired, the finished floor 50 can include both “as forged” and finish machined sections. Regardless, the central wall 50 is formed having a precise finished thickness t2, thereby ensuring the central wall 50 is sufficiently strong, yet finished to the desired thickness to promote optimal cooling and achieving the desired reduced finished weight. Further yet, by allowing for an initially increased thickness t1, the forging tolerances can be slightly increased, thereby reducing the cost associated with forging, and further resulting in reduced scrap. It should be recognized that the entire floor 50 of the combustion bowl 26 can be finish machined, or the finish machining can be restricted to the central portion having the excess material 56 as desired. Accordingly, the combustion bowl floor 50 can be comprised of both an “as forged” surface and a finished machined surface, as desired.

To further yet facilitate minimizing the compression height CH (FIG. 1) and forming the compression height CH having a minimal tolerance, such as between 10-50 μm, at least a portion of the upper combustion surface 24 can be initially forged to leave behind added material 58 (FIG. 3), which allows the forging tolerance limits to be relative broad, thereby enhancing the manufacturability of the piston by reducing cost and potential scrap, and then the added material 58 can be machined in a finishing operation, such as milling or turning, for example, to form the precision upper combustion surface 24 (FIG. 4) and precision CH having a tight, minimal tolerance range. The entire upper combustion surface 24 can be finish machined, or if desired, the finish machining can be restricted to the area including the excess forged material 58, such as an annular outmost region, for example.

Although the invention has been described with respect to preferred embodiments, it is to be also understood that it is not to be so limited since changes and modifications can be made therein which are within the full scope of this invention as detailed by the following claims and any claims ultimately allowed.

What is claimed is:

1. A piston comprising:
a lower member, said lower member having diametrically opposite skirt portions and axially aligned pin bores;
an upper member joined to said lower member, said upper member having a substantially planar upper combustion surface and a combustion bowl depending from said upper combustion surface with an undercrown surface formed directly opposite said combustion bowl and a combustion bowl rim transitioning said combustion bowl with said upper combustion surface, at least one of said combustion bowl, said undercrown surface and said upper combustion surface having a machined surface and an “as forged” surface.

2. The piston of claim 1 wherein at least one of said combustion bowl and said undercrown surface has a machined surface and an “as forged” surface.

3. The piston of claim 2 wherein said machined surface is generally centrally located relative to a central longitudinal axis of the piston and said “as forged” surface extends annularly about said machined surface.

4. The piston of claim 2 wherein said combustion bowl and said undercrown surface have a machined surface and an “as forged” surface.

5. The piston of claim 4 wherein said upper combustion surface has a machined surface and an “as forged” surface.

6. The piston of claim 1 wherein said upper combustion surface has a machined surface and an “as forged” surface.

7. The piston of claim 1 wherein said combustion bowl, said undercrown surface, and said upper combustion surface have a machined surface and an “as forged” surface.

8. The piston of claim 1 wherein said combustion bowl has a recess floor and a combustion bowl wall that converges at an angle of inclination relative to a central longitudinal axis along which the piston reciprocates from said upper combustion surface to said recess floor.

9. The piston of claim 9 wherein said combustion bowl wall remains “as forged”.

10. The piston of claim 9 wherein said combustion bowl wall extends at an angle of inclination relative to said central longitudinal axis between about 1-15 degrees.

11. A method of constructing a piston, comprising:
forming a lower member having diametrically opposite skirt portions and axially aligned pin bores;
forging an upper member having a substantially planar upper combustion surface and a combustion bowl depending from said upper combustion surface with an undercrown surface formed directly opposite said combustion bowl and a combustion bowl rim transitioning said combustion bowl with said upper combustion surface;
joining said lower member to said upper member; and
machining a portion of at least one of said upper combustion surface, said combustion bowl and said undercrown surface, and leaving a portion of at least one of said upper combustion surface, said combustion bowl and said undercrown surface “as forged”.

12. The method of claim 11 further including machining of portion of said combustion bowl and said undercrown surface and leaving a portion of said combustion bowl and said undercrown surface “as forged”.

13. The method of claim 12 further including machining a portion of said combustion bowl and said undercrown surface that is generally centrally located relative to a central longitudinal axis of the piston leaving a portion of said combustion bowl and said undercrown surface “as forged” that extends annularly about the machined surfaces.

14. The method of claim 11 further including machining a portion of said upper combustion surface and leaving a portion of said upper combustion surface “as forged”.

15. The method of claim 11 further including machining a portion of said combustion bowl, said undercrown surface, and said upper combustion surface and leaving a portion of said combustion bowl, said undercrown surface and said upper combustion surface “as forged”.

16. The method of claim 11 further including forging the combustion bowl having a recess floor and a combustion bowl wall that converges at an angle of inclination relative to a central longitudinal axis along which the piston reciprocates from the upper combustion surface to the recess floor.

17. The method of claim 16 further including leaving the combustion bowl wall “as forged”.

18. The method of claim 17 further including forging the combustion bowl wall having an angle of inclination relative to the central longitudinal axis between about 1-15 degrees.
